(19) United States
(12) Patent Application Publication
(10) Pub. No.: US 2012/0240532 A1
(43) Pub. Date: Sep. 27, 2012

(54) FILTER DEVICE AND HOUSING FOR ELECTRONIC DEVICE

(75) Inventors: Shigeaki SAITO, Kawasaki (JP); Takashi Inoue, Kawasaki (JP); Kazuo Fujita, Kawasaki (JP)

(73) Assignee: FUJITSU LIMITED, Kawasaki-shi (JP)

(21) Appl. No.: 13/489,817

(22) Filed: Jun. 6, 2012

Related U.S. Application Data
(63) Continuation of application No. PCT/JP2009/006817, filed on Dec. 11, 2009.

(51) Int. Cl. B01D 33/44; B01D 33/00

(52) U.S. Cl. 55/290; 55/385.4

(57) ABSTRACT

A filter device includes an inclining panel and a movable filter structure. The inclining panel is arranged between a first electronic device housing device and a second electronic device housing device for housing electronic device, and separates the space to the side of the first electronic device housing device and the space to the side of the second electronic device housing device. The movable filter structure circles around to surround the circumference of the inclining panel.

### CROSS-REFERENCE TO RELATED APPLICATION

This application is a continuation of PCT application PCT/JP2009/006817 filed on Dec. 11, 2009, the entire contents of which are incorporated herein by reference.

### FIELD

The embodiment discussed herein is related to a filter device and a housing for electronic device including a movable filter structure.

### BACKGROUND

In recent years, there has been a need for cool the inside of an electronic device so as to realize higher density packaging, and forced-air cooling by a cooling fan has become more common.

In a construction such as that for a housing for electronic device, where the cooled air is taken in by the cooling fan from the intake duct provided on an exterior surface, regular changing or rapid changing of filters attached to the intake duct when a device alarm is emitted is required.

Device alarms include, for example, those notifying that a suction air quantity from the intake duct has been lowered due to dust and the like piled up in the filter or those notifying that the temperature in the device has exceeded the prescribed value.

As examples of devices including filters, refrigerating devices are known in which endless band-shaped filters are arranged in such a manner as to surround the whole circumference of a condenser including a fan, with the middle of this filter laid along the driving roller for rotationally moving the filters.

In addition, as a powder recovery device, a powder recovery device is known which includes an endless filter medium in a casing, the endless filter medium traveling cyclically while shutting off the air inlet of the casing, and which includes a powder and granular material removing device for detaching, from the filter medium, powder and granular materials adhering to the filter medium.

Patent Document 1: Japanese Laid-open Utility Model Publication No. 05-008355

Patent Document 2: Japanese Laid-open Patent Publication No. 11-300132

### SUMMARY

The filter device disclosed herein includes an inclining panel and a movable filter structure. The inclining panel is arranged between a first electronic device housing device and a second electronic device for housing device and separates the space to the side of the first electronic device housing device and the space to the side of the second electronic device housing device. The movable filter structure circles around to surround the circumference of the inclining panel. The housing for electronic device disclosed herein includes the filter device, the first electronic device housing device and the second electronic device housing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an oblique perspective view and a schematic right side view illustrating a housing for electronic device including a filter device.

FIG. 2A is an oblique perspective view illustrating a filter device.

FIG. 2B is a plain view illustrating a filter device.

FIG. 2C is an elevation view illustrating a filter device.

FIG. 2D is a right side view illustrating a filter device.

FIG. 3 is an oblique perspective view illustrating a filter device in a state where an inclining panel is removed.

FIG. 4A is an oblique perspective view illustrating a frame structure.

FIG. 4B is a plain view, an elevation view, an oblique perspective view, and a view in the A direction illustrating a frame structure.

FIG. 5 is an oblique perspective view illustrating a filter.

FIG. 6 is a plain view, an elevation view, and a right side view illustrating an upper side filter holding part.

FIG. 7 is a view in the B direction of FIG. 6.

FIG. 8 is a plain view, an elevation view, and a right side view illustrating a lower side filter holding part.

FIG. 9 is a view in the C direction of FIG. 8.

FIG. 10A is an oblique perspective view illustrating a dust removing structure.

FIG. 10B is a plain view illustrating a dust removing structure.

FIG. 10C is an elevation view illustrating a dust removing structure.

FIG. 10D is a left side view illustrating a dust removing structure.

FIG. 10E is a right side view illustrating a dust removing structure.

FIG. 11 is a plain view illustrating a movable filter structure, a dust removing structure, and a driving part.

FIG. 12 is a view in the D direction of FIG. 11.

FIG. 13A is a sectional view (No.1) taken along I-I of FIG. 12 for explaining operations of a dust removing structure.

FIG. 13B is a sectional view (No.2) taken along I-I of FIG. 12 for explaining operations of a dust removing structure.

FIG. 13C is a sectional view (No.3) taken along I-I of FIG. 12 for explaining operations of a dust removing structure.

FIG. 14 is a sectional view illustrating a movable filter structure, a dust removing structure, and a driving part.

FIG. 15 is an enlarged view of the E part of FIG. 14.

FIG. 16 is a plain view illustrating a frame structure and a movable filter structure.

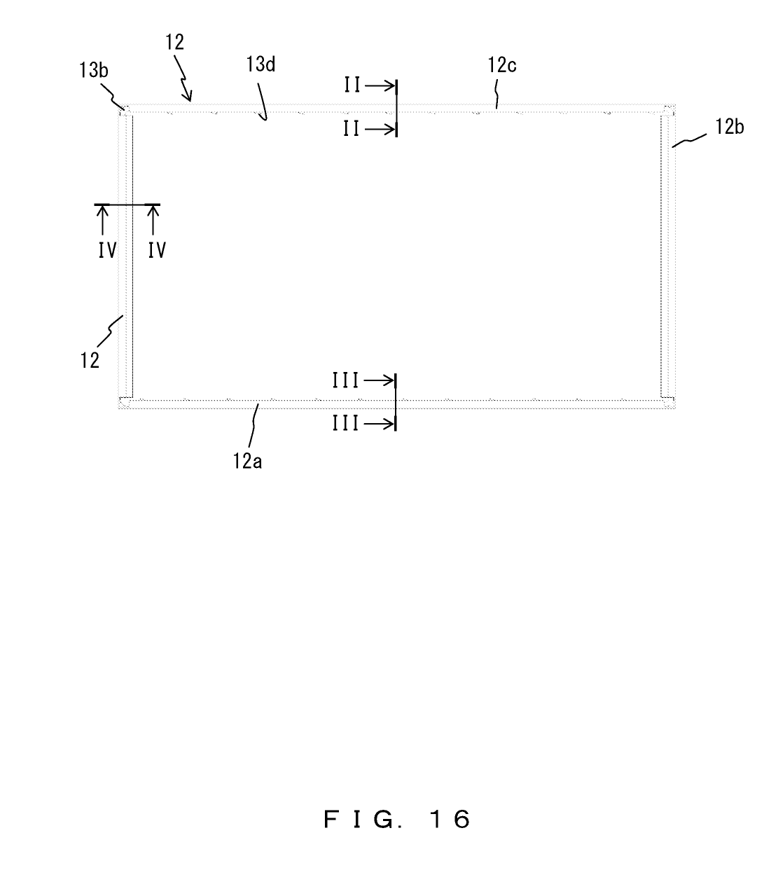

FIG. 17 is a right side view of a frame structure.

FIG. 18 is a sectional view taken along II-II and a sectional view taken along III-III of FIG. 16.

FIG. 19 is a sectional view taken along IV-IV of FIG. 16.

### DESCRIPTION OF EMBODIMENTS

The changing of filters in a housing for electronic device generates not only cost for the filters themselves but also a maintenance load for filters, including the necessity of sending personnel every time the filters are changed when the place where the electronic device is installed is unattended.

Hereafter, a filter device and a housing for electronic device according to an embodiment is explained with reference to the drawings.

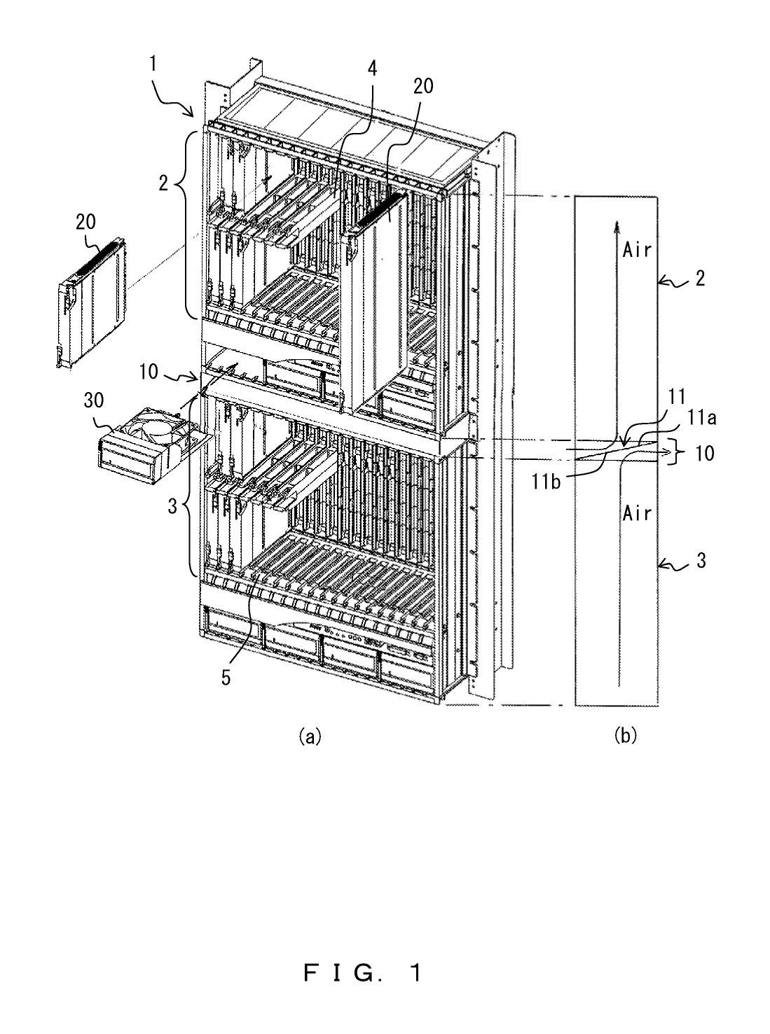

FIG. 1 is an oblique perspective view (FIG. 1(a)) and a schematic right side view (FIG. 1 (b)) illustrating an electronic device housing 1 including a filter device 10.

An electronic device housing 1 as illustrated in FIG. 1 includes a filter device 10, a first electronic device housing device 2, and a second electronic device housing device 3. The electronic device housing 1 is used as, for example, a housing for transmission devices or a housing for servers.

In the first electronic device housing device 2 and in the second electronic device housing device 3, an arbitrary number of electronic devices 20 are housed in a state supported by corresponding supporting parts 4 and 5.

A filter device 10 is arranged between the first electronic device housing device 2 and the second electronic device housing device 3 which is positioned at a lower stage than the first electronic device housing device 2. Between the filter device 10 and the first electronic device housing device 2, a plurality of cooling fans 30 which send air for cooling to the first electronic device housing device 2 are arranged in parallel.

Although a filter device 10 will be mentioned later in detail, the filter device 10 includes an inclining panel 11, for example a heat-shielding plate extending from the front bottom end to the rear upper end as illustrated, for example, in FIG. 1(b).

This inclining panel 11 separates the space to the side of the first electronic device housing device 2 and the side of the second electronic device housing device 3. The inclining panel 11 is provided relative to the alignment direction (in the present embodiment, the vertical direction) of the first electronic device housing device 2 and the second electronic device housing device 3, and is provided obliquely to the plane surface perpendicular to this alignment direction (in the present embodiment, the horizontal plane).

The inclining panel 11 deflects the suction air which is suctioned from the front of the filter device 10 on one surface 11a (the upper surface) upward to the first electronic device housing device 2. In addition, the inclining panel 11 deflects the discharged air which is discharged upward from the second electronic device housing device 3 on the other surface 11b (the bottom surface) to the rear of the filter device 10.

In addition, although the electronic device housing 1 illustrated in FIG. 1 includes two electronic device housing devices 2 and 3, it may include an arbitrary number of three or more electronic device housing devices, and in such a case, it is also preferable to arrange the filter device 10 between each electronic device housing device.

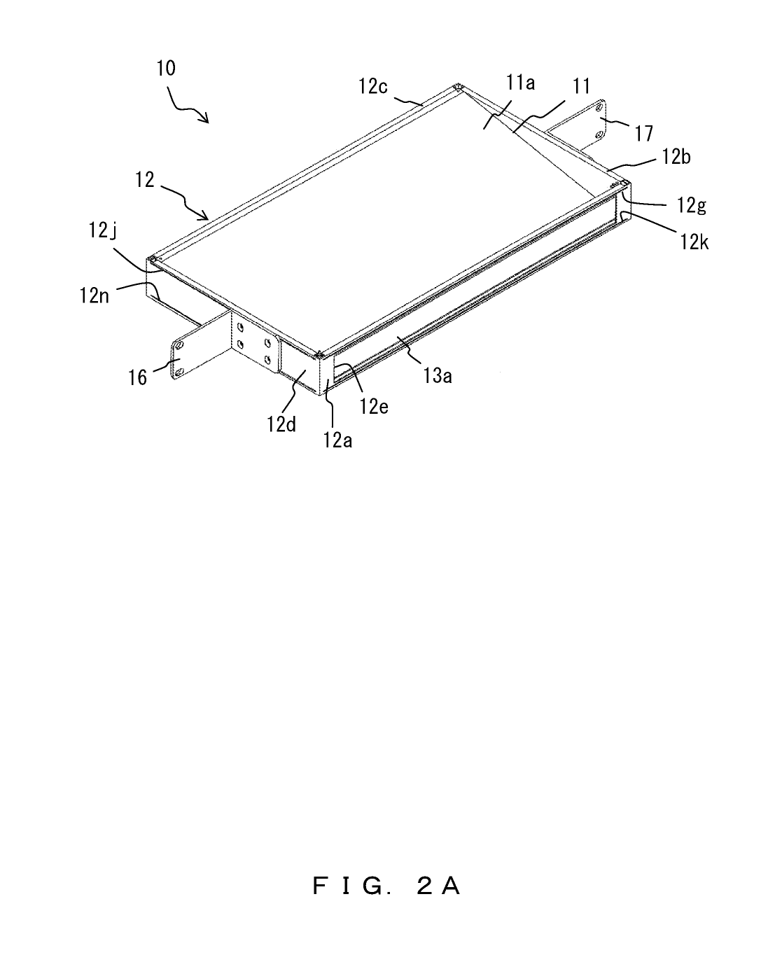

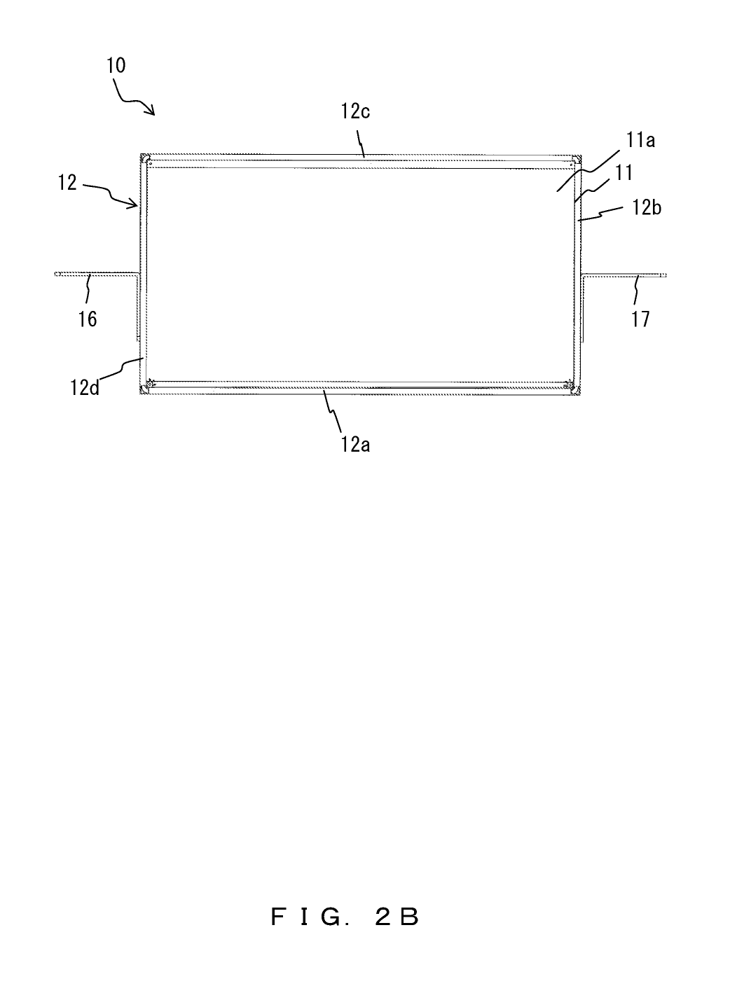

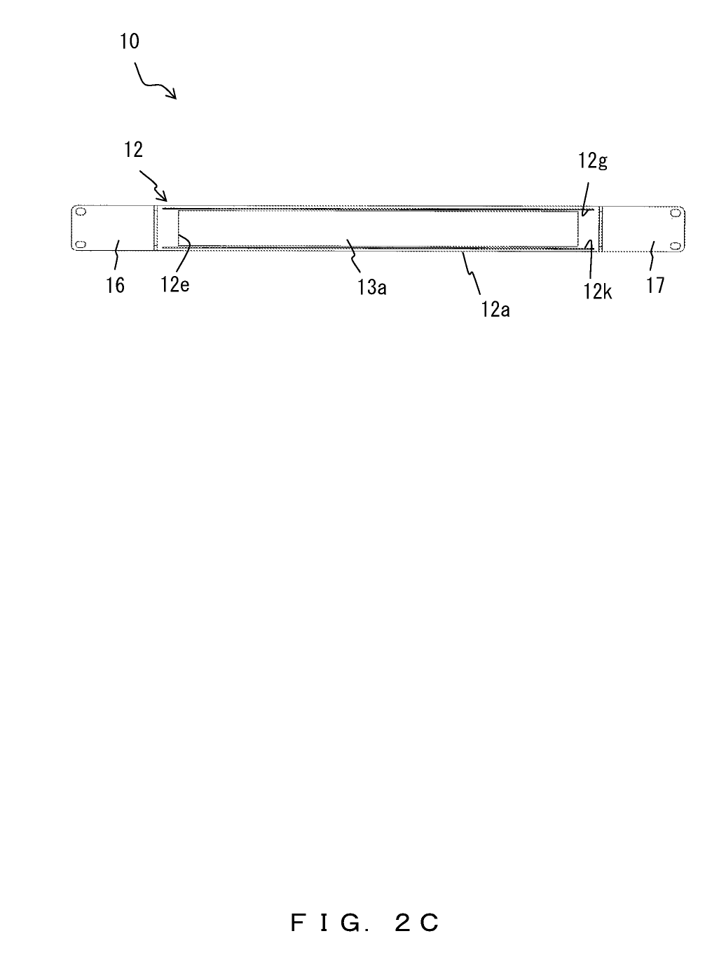

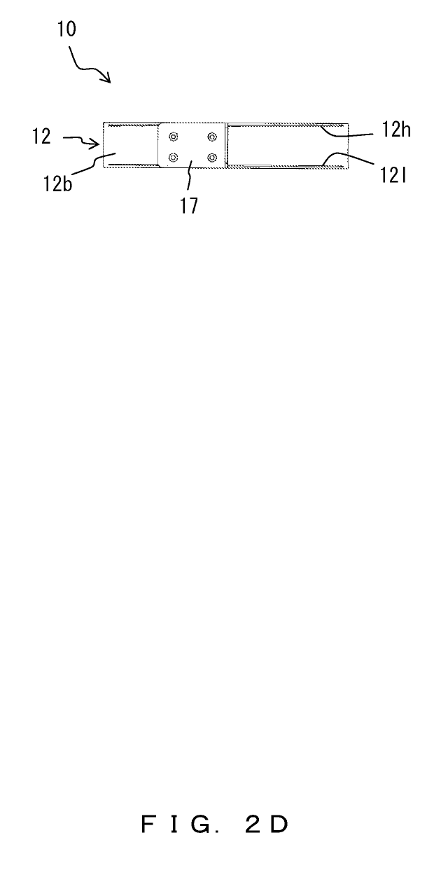

FIGS. 2A to 2D are, respectively, an oblique perspective view, a plain view, an elevation view, and a right side view illustrating the filter device 10.

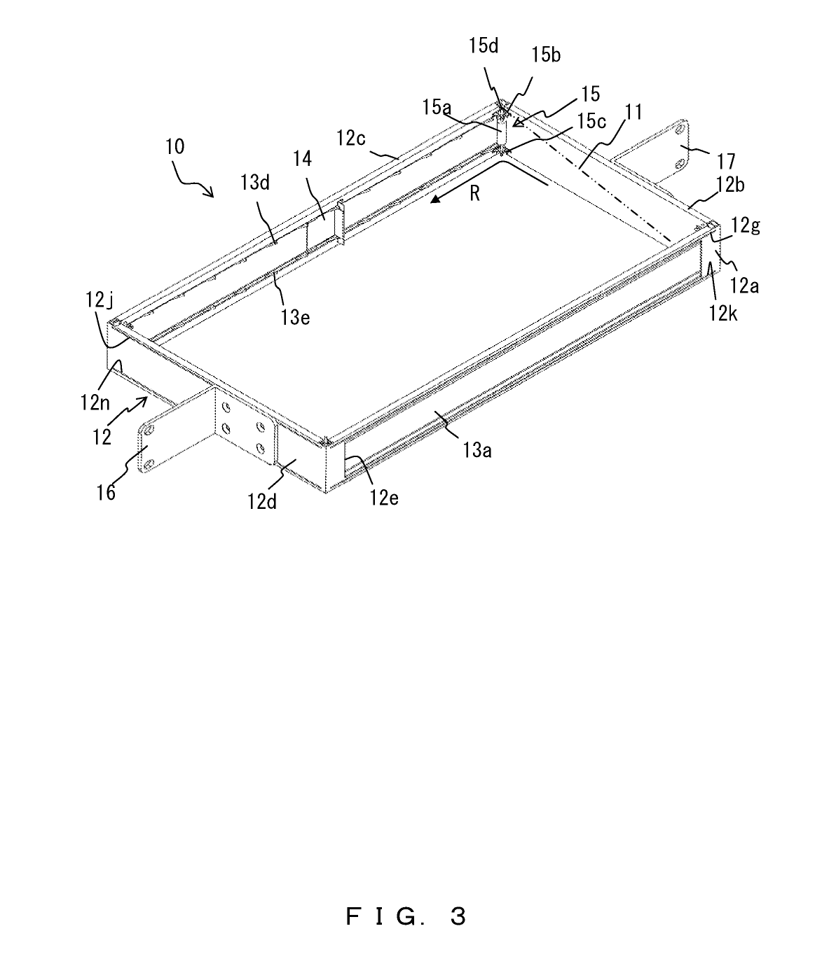

FIG. 3 is an oblique perspective view illustrating the filter device 10 in a state where the inclining panel is removed.

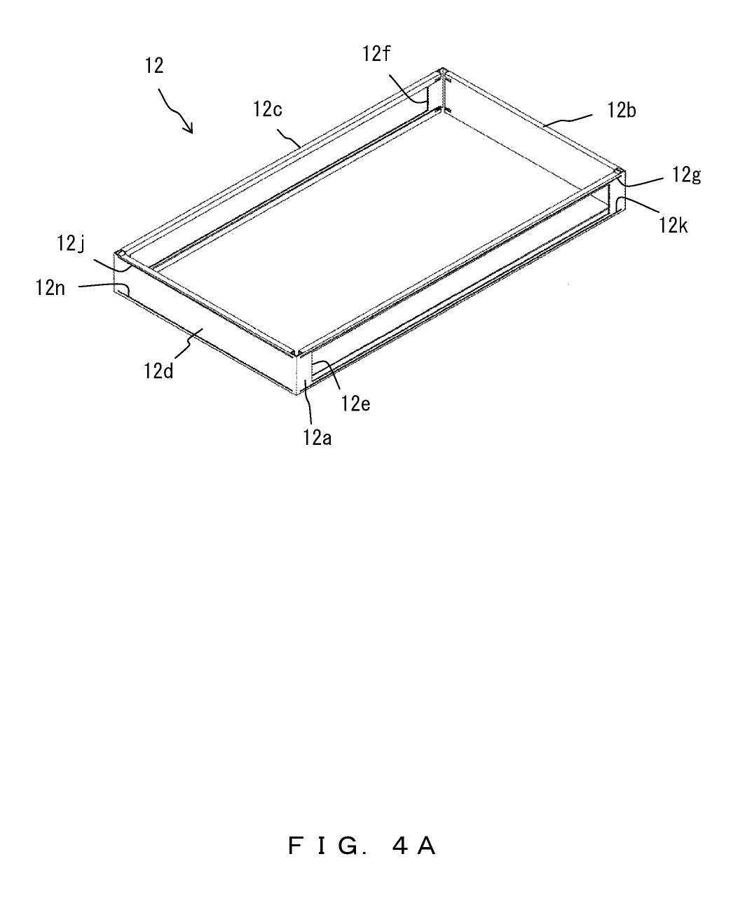

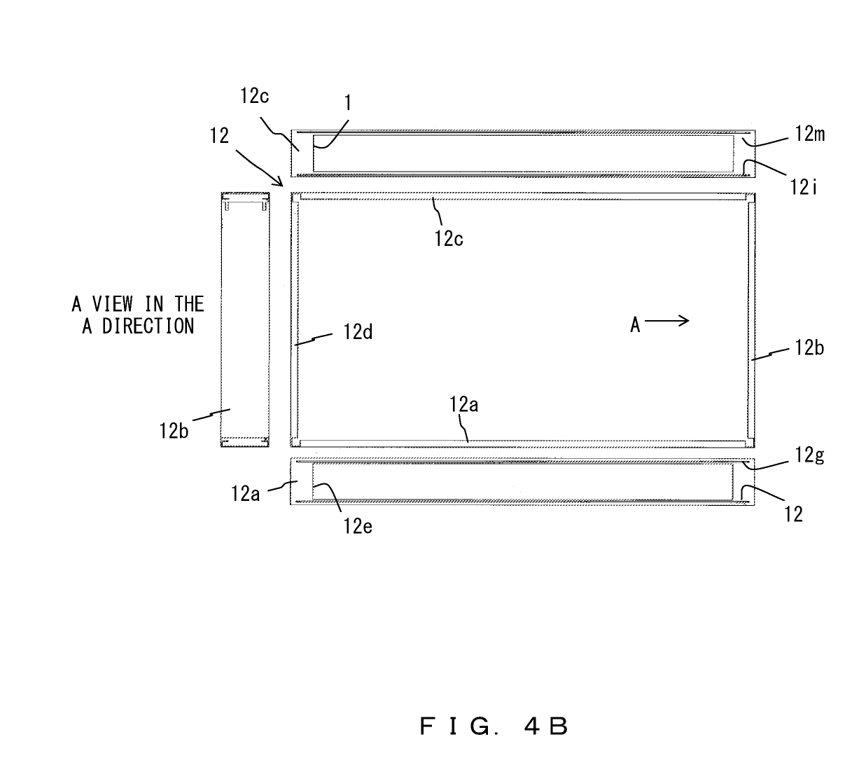

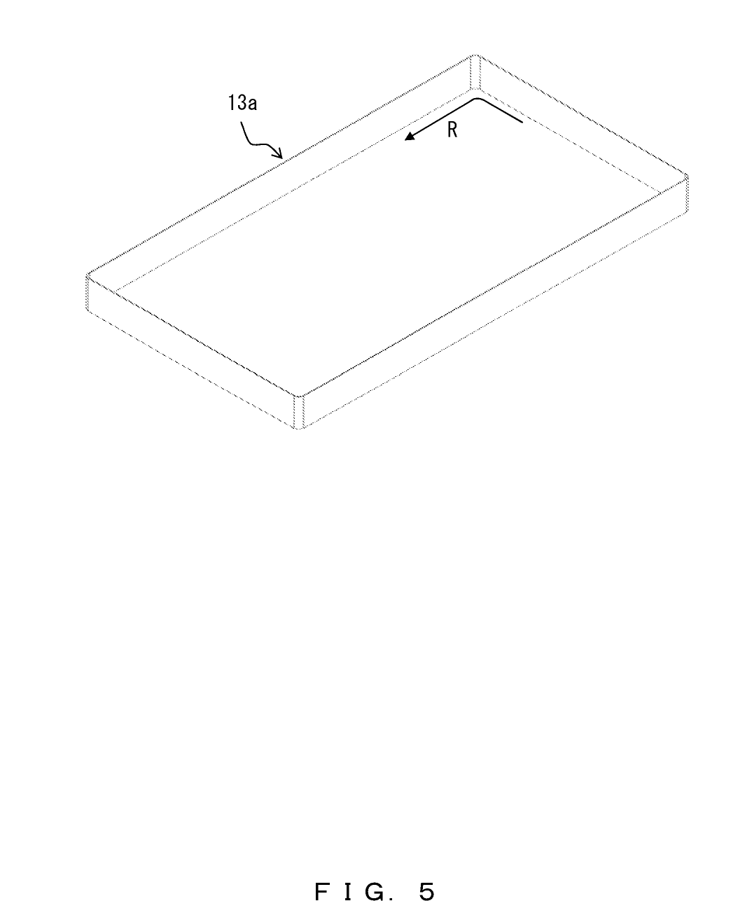

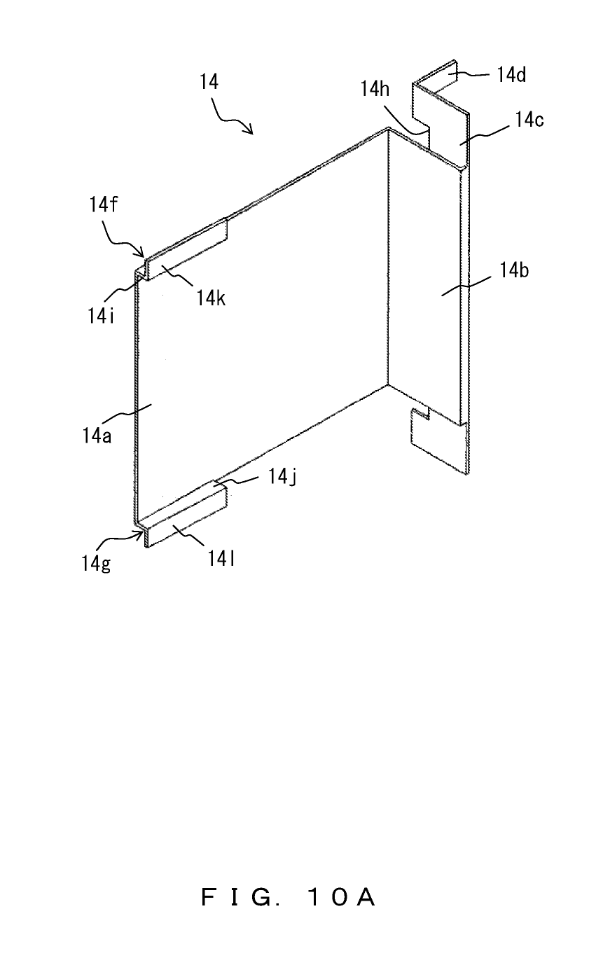

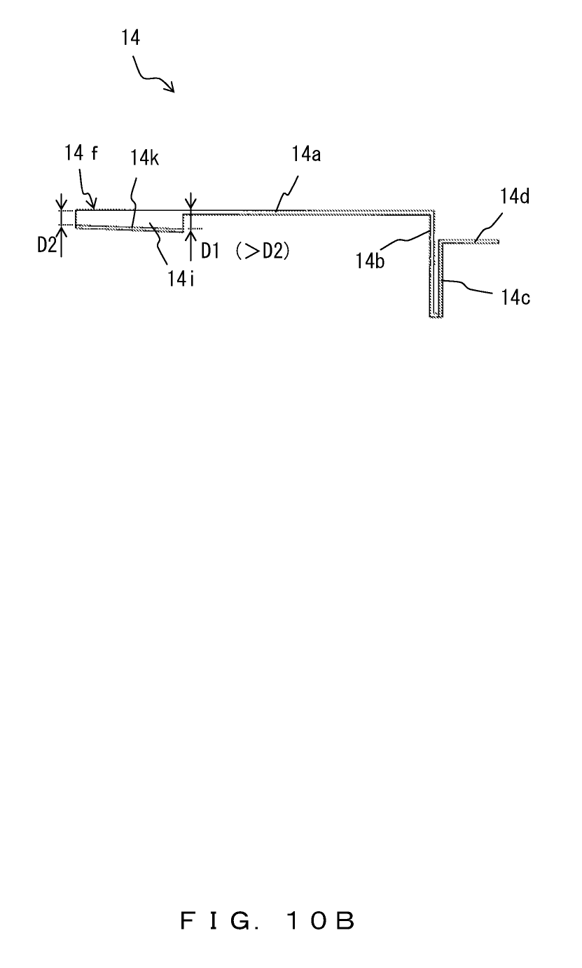

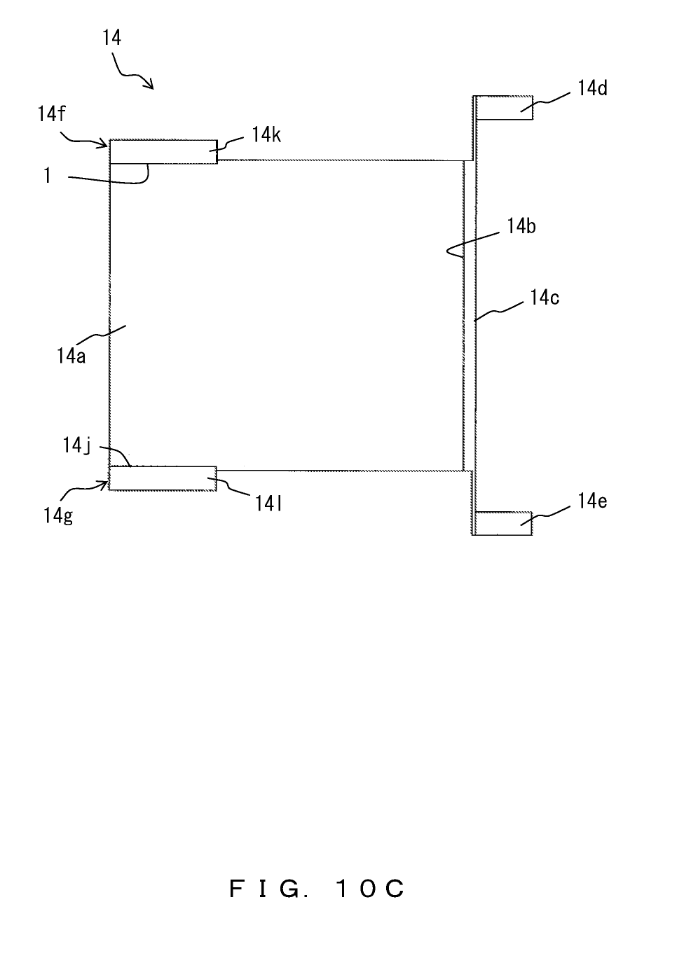

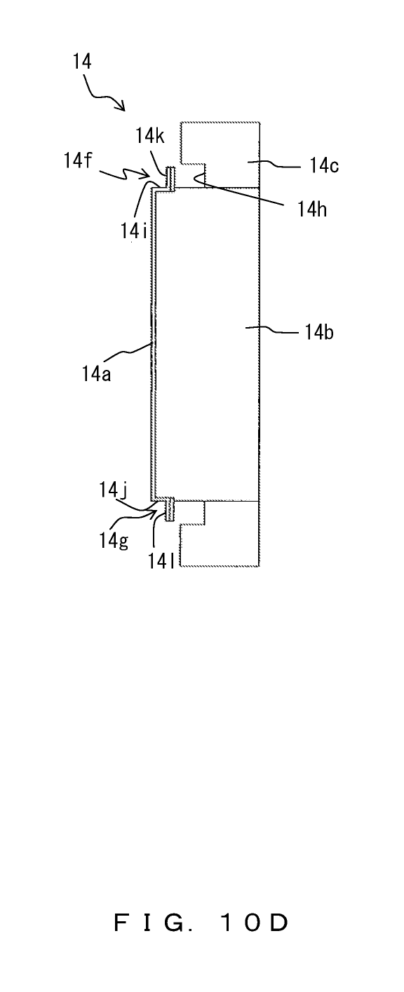

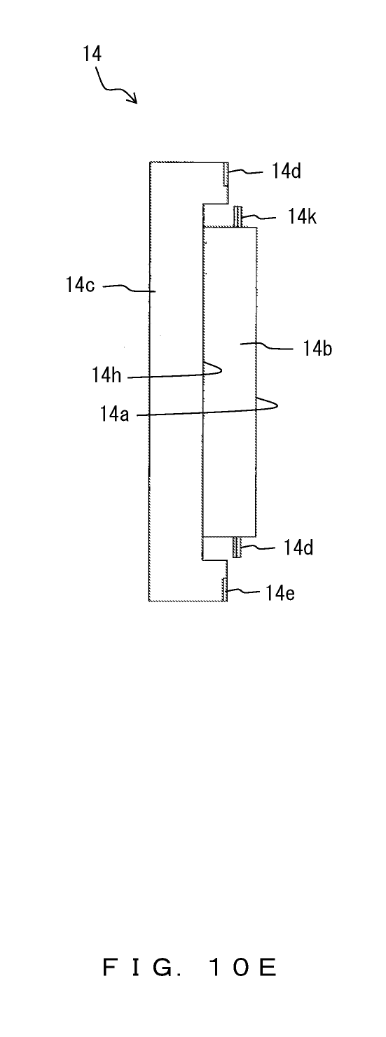

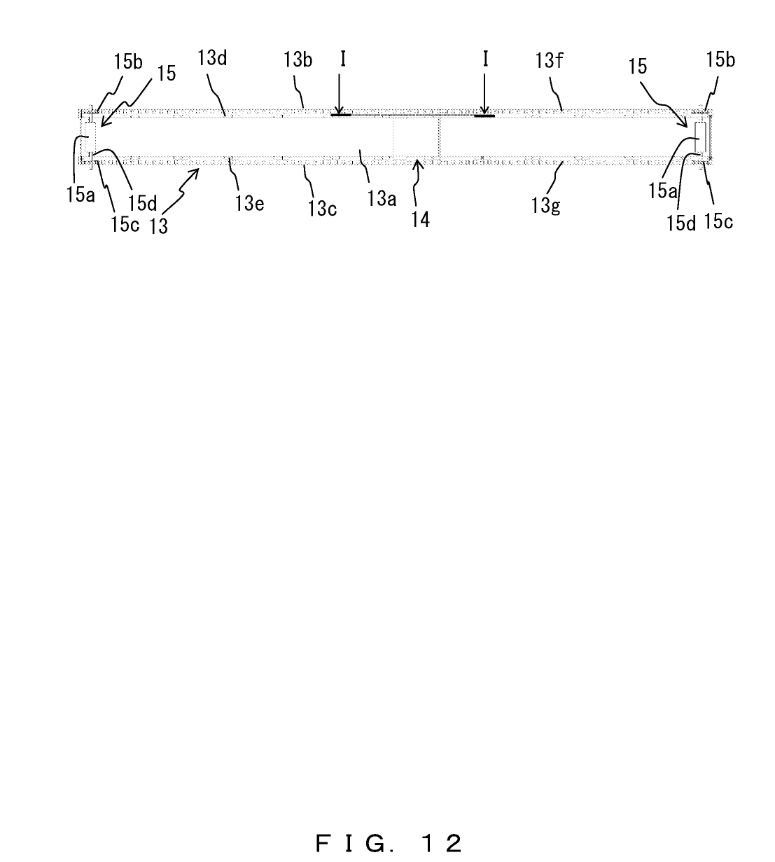

The filter device 10 include the above mentioned inclining panel 11, a frame structure 12 (see FIGS. 4A and 4B), a movable filter structure 13 (see FIGS. 5 to 9), and a dust removing structure 14 (see FIGS. 10A to 10E), and four filter driving parts 15 (see FIGS. 3, 12, 14, and 15).

The inclining panel 11 presents, for example, a plate shape, and as illustrated in FIG. 2A, it is fixed at the lower end of the front surface part 12a and at the upper end of the back surface part 12c of the frame structure 12. The inclining panel 11 separates the space to the side of the first electronic device housing device 2 and the space to the side of the second electronic device housing device 3, and in the present embodiment, separates the vertical space of the filter device 10.

FIG. 4A is an oblique perspective view illustrating the frame structure 12 and FIG. 4B is a plain view, an elevation view, an oblique perspective view, and a view in the A direction illustrating a frame structure 12.

The frame structure 12 includes a front surface part 12a, a right side surface part 12b, a back surface part 12c, and a left side surface part 12d, and presents a rectangular frame shape in a planar view. At the front surface part 12a and the back surface part 12c of the frame structure 12, window parts 12e and 12f are formed.

In addition, the window part 12e of the front surface part 12a is one example of the “intake duct” of the suction air to the first electronic device housing device 2 illustrated in FIG. 1. The window part 12f of the back surface part 12c is one example of the “discharge duct” of the discharged air from the second electronic device housing device 3.

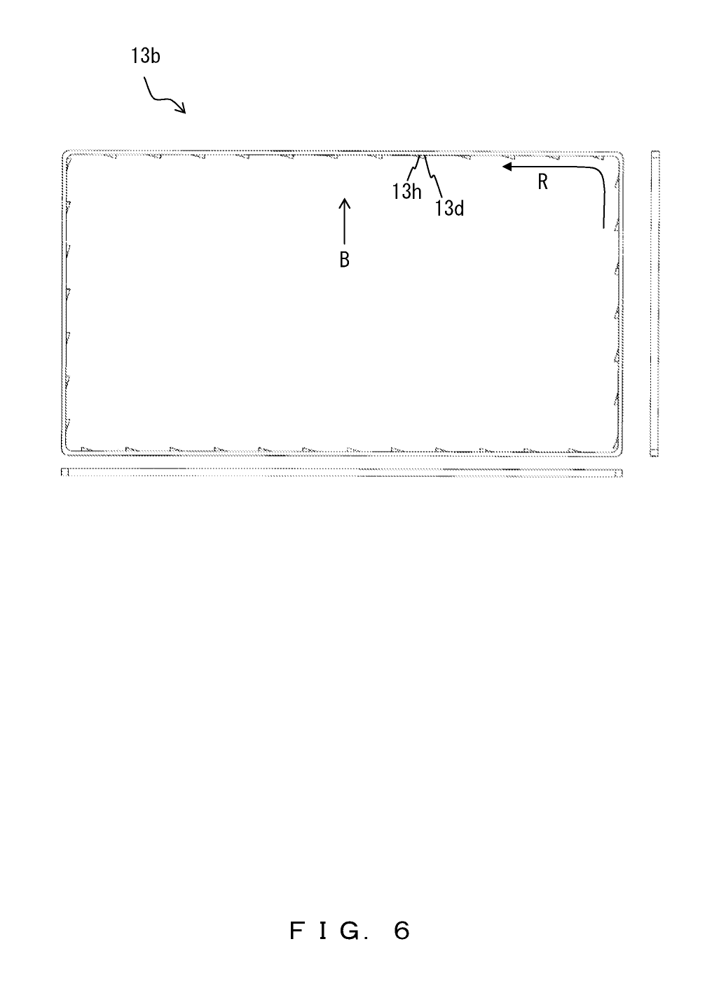

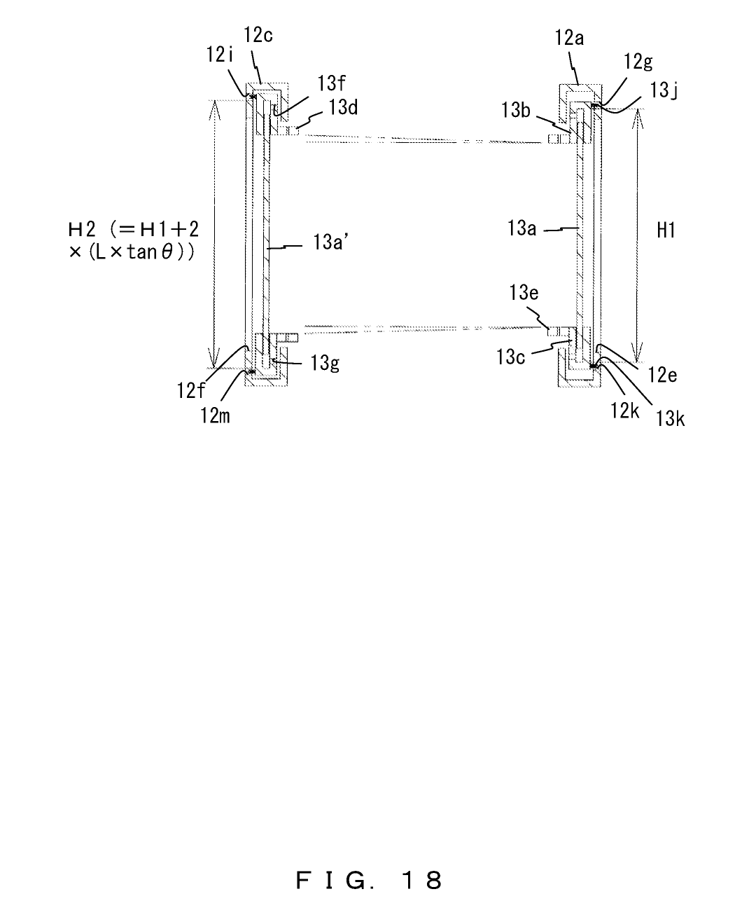

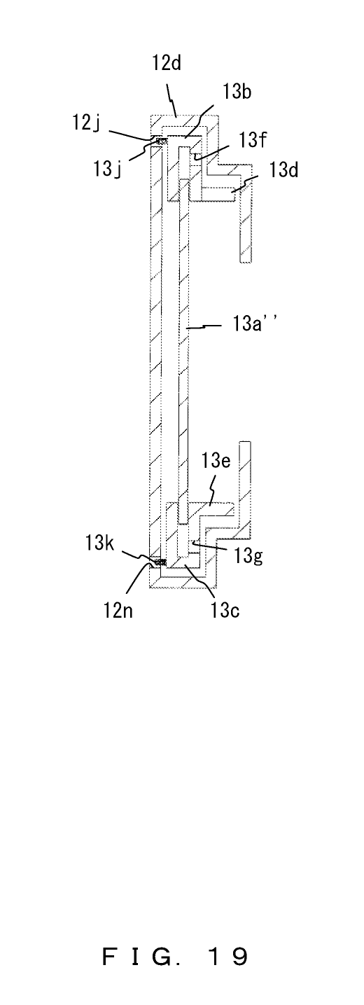

At the front surface part 12a, the right side surface part 12b, the back surface part 12c, and the left side surface part 12d of the frame structure 12, upper side guide holes 12g, 12h, 12i, and 12j are formed, and convex parts 13j for upper side guides (abbreviated in FIG. 6) illustrated in FIGS. 18 and 19 of a later mentioned movable filter structure 13 are inserted into them.

As shown in FIGS. 18 and 19, a plurality of the convex parts 13j for the upper side guide are formed at certain intervals, for example, so that they protrude from the upper end of the outer circumferential surface of the upper side filter holding part 13b to the outside.

At the front surface part 12a, the right side surface part 12b, the back surface part 12c, and the left side surface part 12d of the frame structure 12, lower side guide holes 12k, 121, 12m, and 12n are formed, and convex parts 13k for lower side guides (abbreviated in FIG. 6) illustrated in FIGS. 18 and 19 of a movable filter structure 13 are inserted into them.

As shown in FIGS. 18 and 19, a plurality of the convex parts 13k for the lower side guide are formed at certain intervals, for example, so that they protrude from the lower end of the outer circumferential surface of the lower side filter holding part 13c to the outside.

The movable filter structure 13 is supported, for example, by the frame structure 12 and four filter driving parts 15. The movable filter structure 13 is supported by the frame structure 12 via the convex parts 13j for the upper side guide and the convex parts 13k for the lower side guide being inserted into the upper side guide holes 12g to 12j and the lower side guide holes 12k to 12n. In addition, the movable filter structure 13 is supported by four filter driving parts 15 via the later mentioned upper side meshing hole 13f and lower side meshing hole 13g meshing with an upper side gear 15b and a lower side gear 15c.

The upper side guide hole 12g and the lower side guide hole 12k of the front surface part 12a are formed in parallel with each other with the window part 12e formed on the front surface part 12a therebetween. Likewise, the upper side guide hole 12i and the lower side guide hole 12m of the back surface part 12c are formed in parallel with each other with the window part 12f formed on the back surface part 12c therebetween.

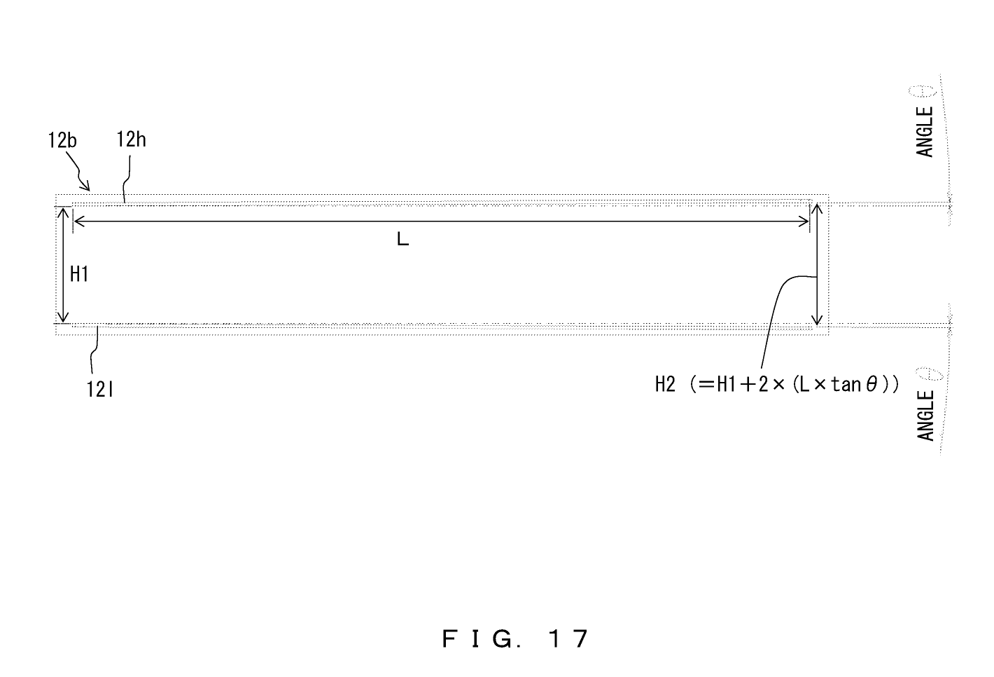

As illustrated in FIG. 17, the length between the upper side guide hole 12h and the lower side guide hole 121 at the front end side of the right side surface part 12b is H1, which is the same length as the length between the upper side guide hole 12g and the lower side guide hole 12k of the front surface part 12a.

The upper side guide hole 12h and the lower side guide hole 121 of the right side surface part 12b are inclined at the angle e from the horizontal plane respectively so that they are apart from each other from the front end side to the rear end side. The length between the upper side guide hole 12h and the lower side guide hole 121 at the rear end side of the right side surface part 12b is H2, which is the same length as the length between the upper side guide hole 12i and the lower side guide hole 12m of the back surface part 12c.

Here, the respective lengths in the horizontal direction of the upper side guide hole 12h and the lower side guide hole 121 of the right side surface part 12b is the length L. Therefore, the length H2 is represented by “H1+2×(Ltanθ)”.

Although not illustrated in the drawings, the upper side guide hole 12h and the lower side guide hole 121 of the left side surface part 12d are respectively inclined at the angle θ from the horizontal plane so that they are apart from each other from the front end side to the rear end side. The length between the upper side guide hole 12j and the lower side guide hole 12n of the left side surface part 12d is the length H1 at the front end side and the length H2 at the rear end side, the same as the right side surface 12b.

As will be mentioned in detail later, the movable filter structure 13 circles around in such a manner as to surround the circumference of the inclining panel 11 in the counterclockwise direction in a planar view, as illustrated in

FIG. 3. Therefore, an elastic filter 13a (the movable filter structure 13) expands by being pulled in the height direction between the upper side guide hole 12h and the lower side guide hole 121 of the right side surface part 12b as it moves from the front end to the rear end (the filter 13a′ in the sectional view taken along II-II on the left side of the page in FIG. 18).

In addition, the expanded filter 13a′ circles around keeping the expanded state being pulled in the height direction even between the upper side guide hole 12i and the lower side guide hole 12m which are parallel with each other at the back surface part 12c. Then, in the expanded filter 13a′, the degree of being pulled is weakened between the upper side guide hole 12j and the lower side guide hole 12n of the left side surface part 12d as it moves from the rear end to the front end (the filter 13a″ illustrated in FIG. 19) and it restores its original height at the front end of the left side surface part 12d.

The upper side guide holes 12g to 12j and the lower side guide holes 12k to 12n mentioned so far are examples of the “guide parts” of the “filter expansion structure” which expand the movable filter structure 13 at the back surface (the part where dust is removed by the dust removing structure 14).

As mentioned so far, the upper side guide holes 12g to 12j and the lower side guide holes 12k to 12n expand the filter 13a of the movable filter structure 13 by increasing or decreasing intervals with each other over the circumferential direction (arrow R) of the movable filter structure 13.

In addition, among the movable filter structures 13, the parts which increase or decrease the intervals between the upper side guide holes 12g to 12j and the lower side guide holes 12k to 12n may be limited solely to the parts where dust is removed by the dust removing structure 14 (for example, the upper side guide hole 12i and the lower side guide hole 12m of the back surface part 12c).

Also, the upper side guide holes 12g to 12j and the lower side guide holes 12k to 12n may be provided in the movable filter structure 13, while the convex part 13j for the upper side guide and the convex part 13k for the lower side guide may be provided in the frame structure 12. Further, as “guide parts”, parts may be used that can guide the movable filter structure 13 even though not by the guide holes or convex parts for guiding. Moreover, as “filter expansion structure”, since parts that expand the movable filter structure 13 are acceptable, other structures may also be adopted including ones that pull or press the filter 13a.

Also, although the right side surface part 12b of the frame structure 12 is illustrated in such a way that it does not open on the inner circumferential surface (inside of the revolving orbit) in FIGS. 3 and 4A, it is defined to open on the inner circumferential surface at the left side surface part 12d, as illustrated in FIG. 19.

At the right side surface part 12b and the left side surface part 12d of the frame structure 12, L-shaped attachments 16 and 17 are fixed, respectively. The filter device 10 is attached to the right and left struts 6 and 7 of the electronic device housing 1 with, for example, the attachments 16 and 17.

FIG. 5 is an oblique perspective view illustrating the filter 13a.

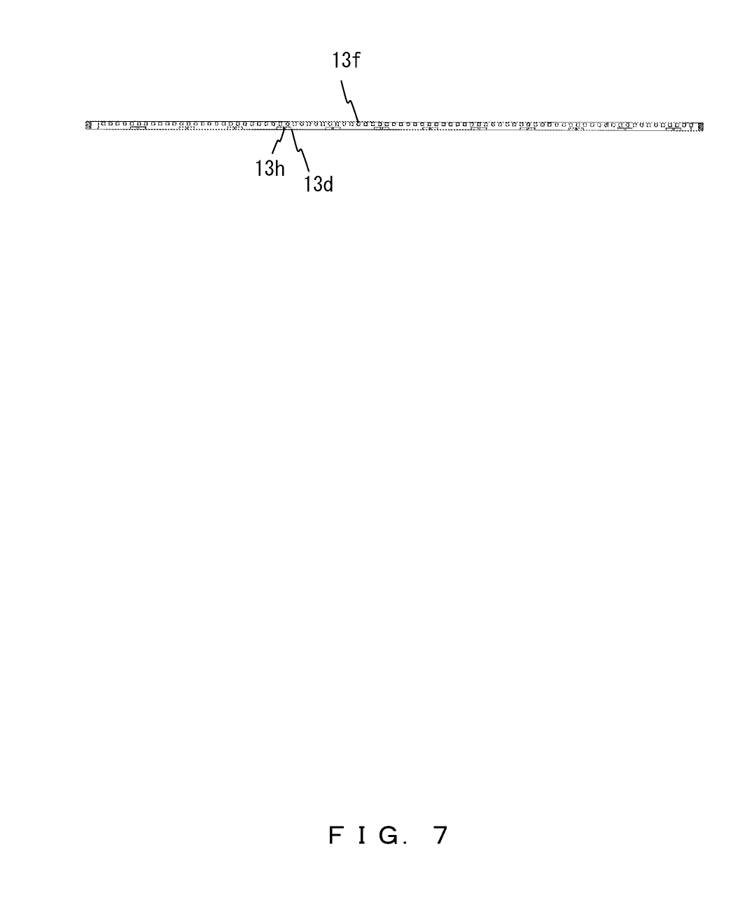

FIG. 6 is a plain view, an elevation view, and a right side view illustrating an upper side filter holding part 13b, and FIG. 7 is a view in the B direction of FIG. 6.

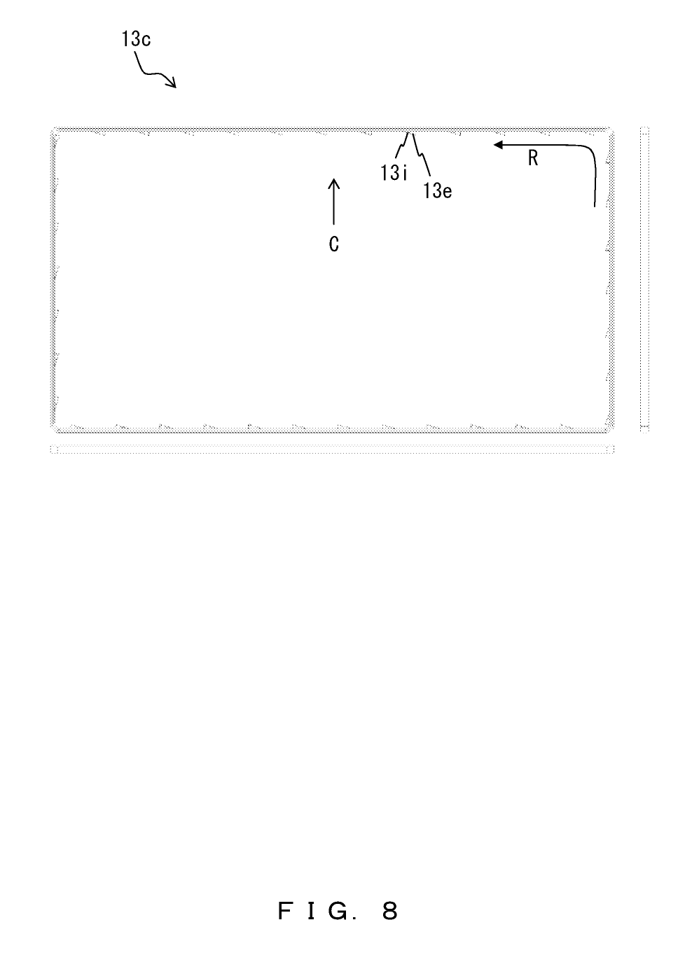

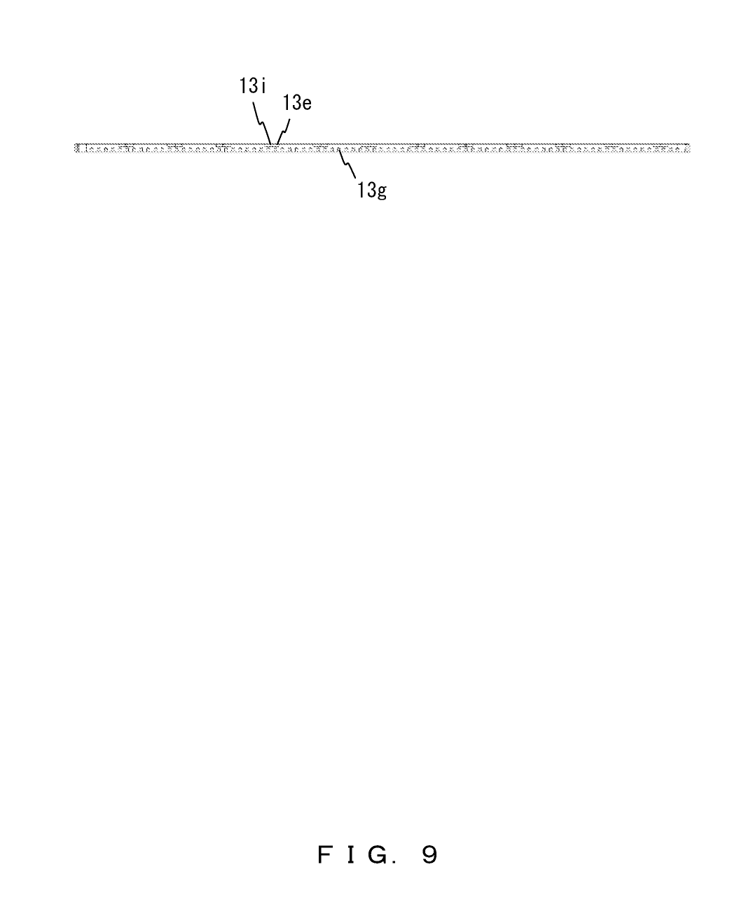

FIG. 8 is a plain view, an elevation view, and a right side view illustrating a lower side filter holding part, and FIG. 9 is a view in the C direction of FIG. 8.

The movable filter structure 13 includes the elastic filter 13a illustrated in FIG. 5, the upper side filter holding part 13b illustrated in FIGS. 6 and 7, and the lower side filter holding part 13c illustrated in FIGS. 8 and 9.

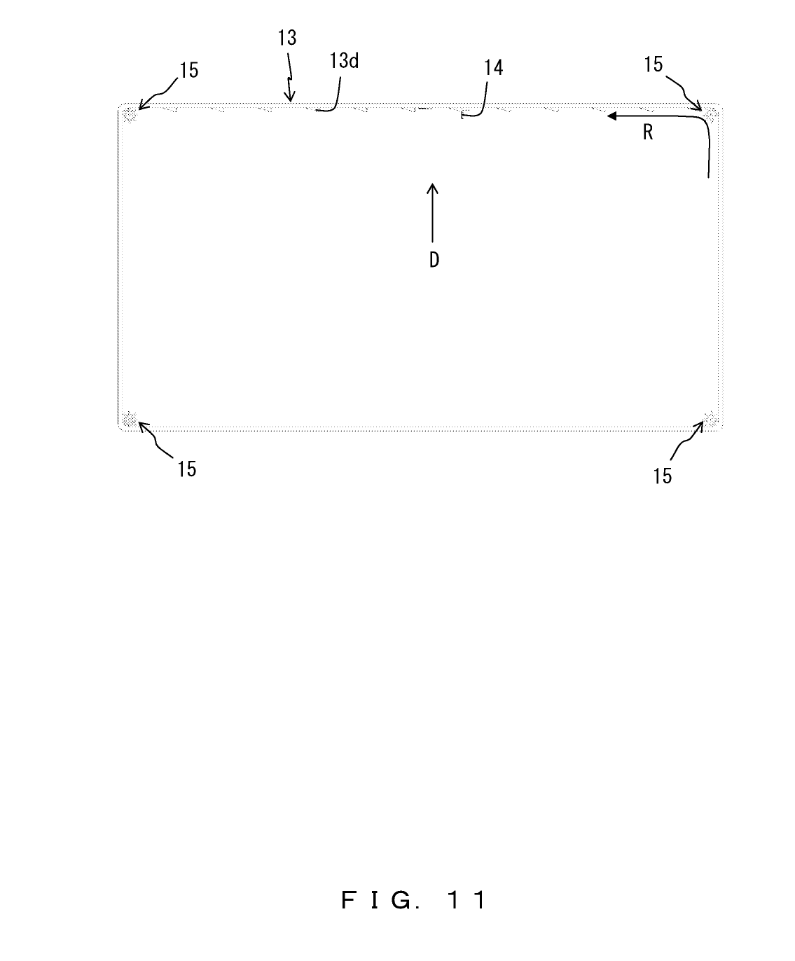

The movable filter structure 13 circles around to surround the circumference of the inclining panel 11 in the counterclockwise direction (circumferential direction R) by a later mentioned filter driving part 15, as illustrated in FIG. 11. Since the frame structure 12 presents a rectangular shape in a planar view as mentioned above, the filter 13a, the upper side filter holding part 13b, and the lower side filter holding part 13c have flexibility so that they may circle around the four corner parts of the frame structure 12.

The filter 13a is composed of elastic materials and presents a band shape. Although the filter 13a is formed in endless loops, dust may be removed when positioned at at least one of the window parts 12e and 12f . Therefore, the filter 13a may include a plurality of filters of a size large enough to cover the window parts 12e and 12f in the circumferential direction.

The upper side filter holding part 13b and the lower side filter holding part 13c present loop shapes, respectively, and as illustrated in FIGS. 18 and 19, they hold the upper end and the lower end of the filter 13a by, for example, clamping. The upper side filter holding part 13b and the lower side filter holding part 13c are provided symmetrically with the filter 13a therebetween.

At the lower end of the inner circumference of the upper side filter holding part 13b, as illustrated in FIGS. 6, 7, 18, and 19, a plurality of upper side projection parts 13d which press the upper side pressed part 14f of the dust removing structure 14 (FIGS. 3, 10A, etc) are arranged at regular intervals in the circumferential direction (arrow R) of the movable filter structure 13.

Likewise, at the upper end of the inner circumferential surface of the lower side filter holding part 13c, as illustrated in FIGS. 8, 9, 18, and 19, a plurality of the lower side projection parts 13e which press the lower side pressed part 14g of the dust removing structure 14 are provided at regular intervals in the circumferential direction (arrow R).

For example, the upper side projection part 13d and the lower side projection part 13e increase in thickness, which is the projection amount, as they move from the front end to the rear end in the circumferential direction (arrow R), and present a right triangle shape in a planar view in which the rear end surface forms the right angle between the upper side filter holding part 13b and the lower side filter holding part 13c.

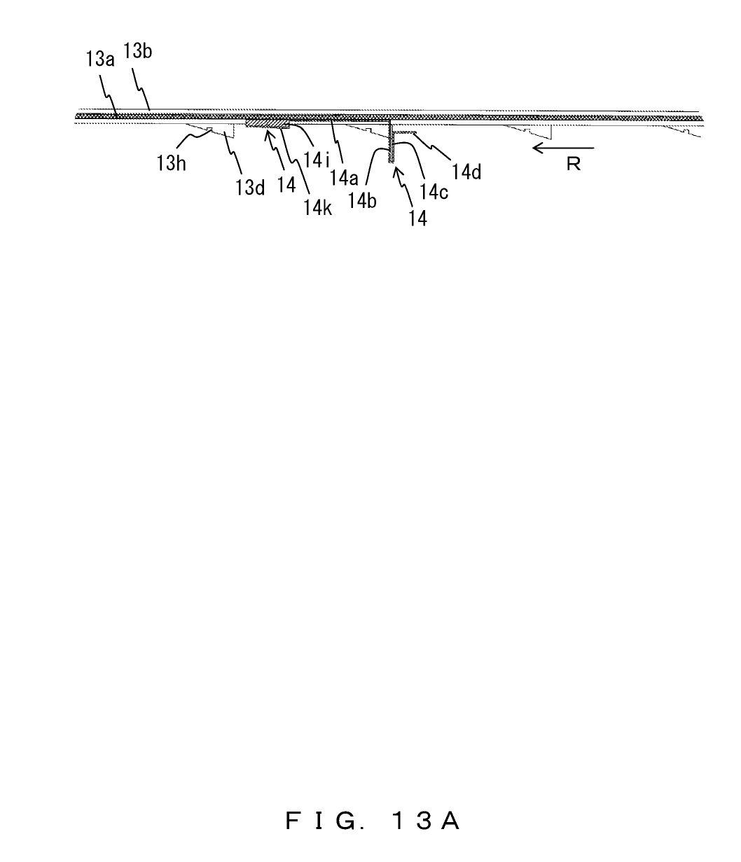

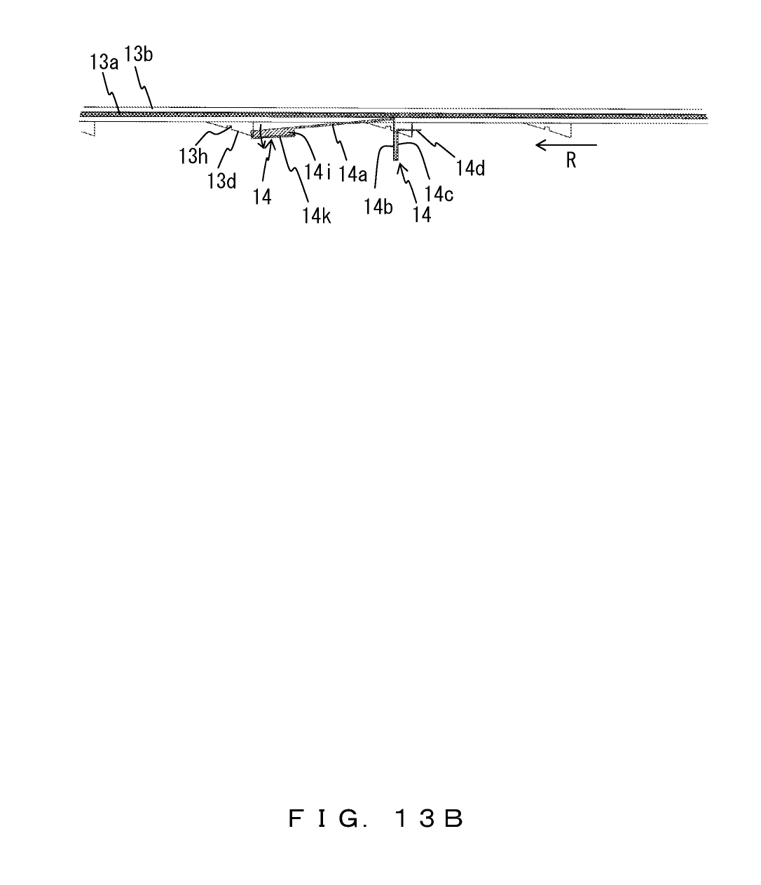

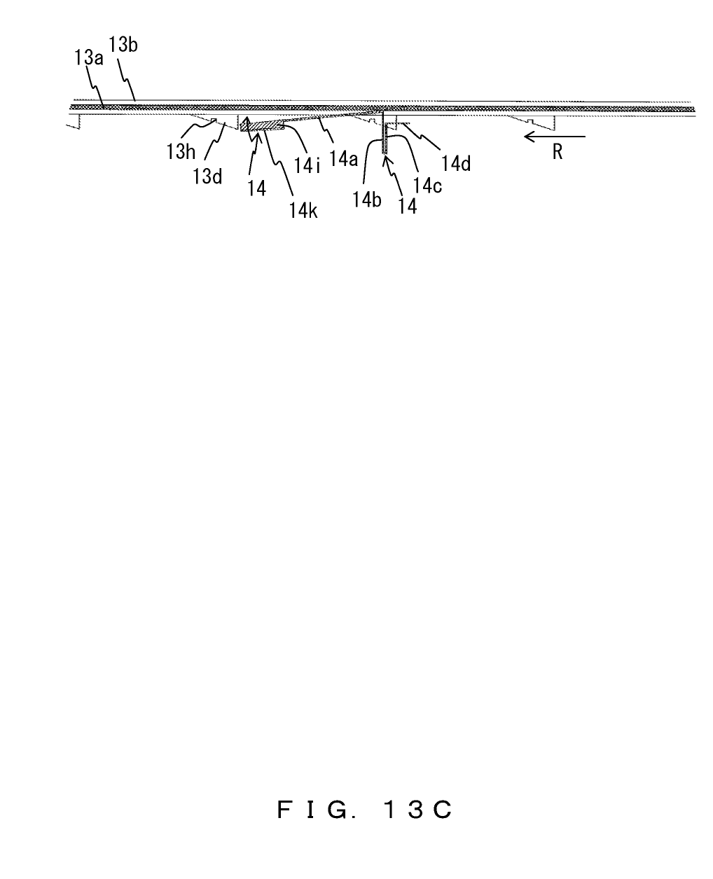

At the upper side projection part 13d and the lower side projection part 13e, as also illustrated in FIGS. 13A to 13C, slits 13h and 13i, which are concave parts, are formed on the inclining surface at the inner circumferential side of the upper side filter holding part 13b and the lower side filter holding part 13c. These slits 13h and 13i ease bending stress applied to the upper side projection part 13d and the lower side projection part 13e when the movable filter structure 13 circles around the four corners of the filter device 10. This facilitates circling of the upper side projection part 13d and the lower side projection part 13e, and eventually, the circling of the movable filter structure 13.

The number of the respective upper side projection parts 13d and of the lower side projection parts 13e maybe one, and also, as illustrated in FIGS. 6 to 9, may be several dozen. This number may appropriately be decided depending on the later-mentioned rotation number of the motor 15a of the filter driving part 15, the capability of removing dust of the dust removing structure 14, and the amount of dust adhering to the filter 13a.

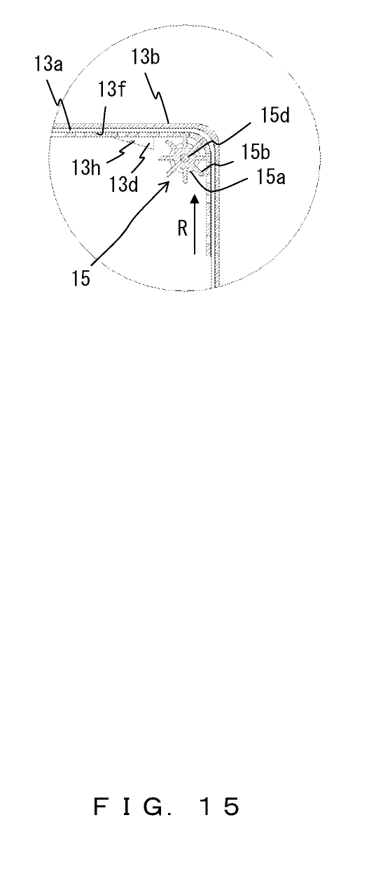

At the upper end of the inner circumference of the upper side filter holding part 13b, the upper side meshing holes 13f that mesh with the upper side gear 15b of the filter driving part 15 illustrated in FIG. 15 are formed at regular intervals in the circumferential direction (arrow R). At the lower end of the inner circumference of the lower side filter holding part 13c, the lower side meshing holes 13g that mesh with the lower side gear 15c of the filter driving part 15 are formed at regular intervals in the circumferential direction (arrow R).

FIGS. 10A to 10E are, respectively, an oblique perspective view, a plain view, an elevation view, a left side view, and a right side view illustrating the dust removing structure 14.

The dust removing structure 14 is formed by, for example, appropriately bending a thin plate which has been processed into a prescribed shape. The dust removing structure 14 is, for example, provided inside of the revolving orbit of, for example, the movable filter structure 13 and dusts off the dust on the filter 13a outside of the above mentioned revolving orbit from the window part 12f of the back surface part 12c of the frame structure 12.

The dust removing structure 14 includes a duster part 14a, a duster supporting part 14b, a base part 14c, an upper side fixture part 14d, a lower side fixture part 14e, an upper side pressed part 14f, and a lower side pressed part 14g.

The duster part 14a presents a long rectangular shape in the circumferential direction of the movable filter structure 13 and is provided in such a manner that it faces the movable filter structure 13.

The duster supporting part 14b extends from the right end of the duster part 14a (the right side of the page in FIG. 10B) to the rear (the direction away from the movable filter structure 13, i.e., the lower part of the page in FIG. 10B) movable filter structure. The duster supporting part 14b presents a rectangular shape which is shorter in the front to back direction than in the height direction and has an upper end position and a lower end position that are the same as those of the duster part 14a.

The base part 14c is in parallel with the duster supporting part 14b with the two right-angled bending parts at the rear-end side of the duster part supporting part 14b therebetween and faces the duster supporting part 14b with a narrow interval between them. The base part 14c protrudes further upward and downward than do the duster part 14a and the duster supporting part 14b.

The base part 14c is formed longer in the height direction and shorter in the front-back direction than the duster supporting part 14b. In the base part 14c, the rectangular shaped concave part 14h is formed on the side of the movable filter structure 13. This concave part 14h allows the upper side projection part 13d of the upper side filter holding part 13b and the lower side projection part 13e of the lower side filter holding part 13c to pass between the duster supporting parts 14b. Therefore, the concave part 14h is formed longer in the height direction than the total height of the duster supporting part 14b, the upper side projection part 13d, and the lower side projection part 13e.

The upper side fixture part 14d and the lower side fixture part 14e are formed by the upper end and the lower end of the front end of the base part 14c being folded back to the opposite side of the duster part 14a. The dust removing structure 14 is fixed to the frame structure 12 in the upper side fixture part 14d and the lower side fixture part 14e.

The upper side pressed part 14f and the lower side pressed part 14g include the upper side horizontal part 14i and the lower side horizontal part 14j which extend from the left end of the upper end and the lower end of the duster part 14a to the rear, the upper side abutting part 14k and the lower side abutting part 141 being formed by bending the rear end of these horizontal parts 14i and 14j upward.

Regarding the depth of the upper side horizontal part 14i and the lower side horizontal part 14j in the front-back direction, as shown in FIG. 10B, the depth D1 at the right end is larger than the depth D2 at the left end. This allows the upper side projection part 13d of the movable filter structure 13 which circles around from right to left to enter into upper side of the upper side horizontal part 14i, and the lower side projection part 13e of the movable filter structure 13 which circles around from right to left to enter into the lower side of the lower side horizontal part 14j more easily, respectively. Further, this allows the upper side projection part 13d to press the upper side abutting part 14k, and the lower side projection part 13e to press the lower side abutting part 141, more easily, respectively.

When the upper side abutting part 14k and the lower side abutting part 141 are pressed to the upper side projection part 13d and the lower side projection part 13e, the duster part 14a is distanced from the movable filter structure 13 to the rear, and its reaction makes the duster part 14a beat the filter 13a of the movable filter structure 13.

Although the duster part 14a for example rotates with the pressed and distanced position and the position of beating the filter 13a with the bending part between the duster part 14a and the duster supporting part 14b as a rotational axis, the bending part between the duster supporting part 14b and the base part 14c may also serve as a rotational axis.

In addition, so long as it has a function of beating a filter 13a, the duster part 14a may take any shape other than a plain surface, including, for example, a curved surface or the like so that it has a curvature that is distanced from the movable filter structure 13 as it moves from the right end to the left end.

Although the dust removing structure 14 removes dust by beating the filter 13a with the duster part 14a in the present embodiment, the dust may be removed by other means. For example, the dust removing structure 14 may have other mechanisms including a discharging mechanism in which dust is removed by discharging air, an absorbing mechanism in which dust is removed by absorbing air, a rubbing mechanism in which dust is rubbed off by brushes or the like, and a scraping mechanism in which dust is scraped off by brushes or the like.

The filter driving part 15 as illustrated in FIGS.

3, 12, 14, and 15 is arranged at each of the four corners of the frame structure 12. The four filter driving parts 15 include, respectively, a motor 15a, an upper side gear 15b, a lower side gear 15c, and a driving axis 15d.

The motor 15a drives the driving axis 15d in the counterclockwise direction. The upper side gear 15b and the lower side gear 15c fixed in this driving axis 15d turn in the counterclockwise direction with the driving axis 15d.

As mentioned above, with the upper side gear 15b and the lower side gear 15c, the upper side meshing hole 13f and the lower side meshing hole 13g of the movable filter structure 13 are meshed. Therefore, the movable filter structure 13 circles around to surround the circumference of the inclining panel 11 in the counterclockwise direction driven by the motor 15a.

In order to avoid interference between the frame structure 12 and the upper side gear 15b and the lower side gear 15c, notched openings are formed in the front surface part 12a, the right side surface part 12b, the back surface part 12c, and the left side surface part 12d. The filter driving part 15 may not circle around the movable filter structure 13 all the time but may circle around it, for example, regularly.

Hereafter, operation of the filter device 10 is explained, appropriately abbreviating the part overlaps with the above mentioned explanation.

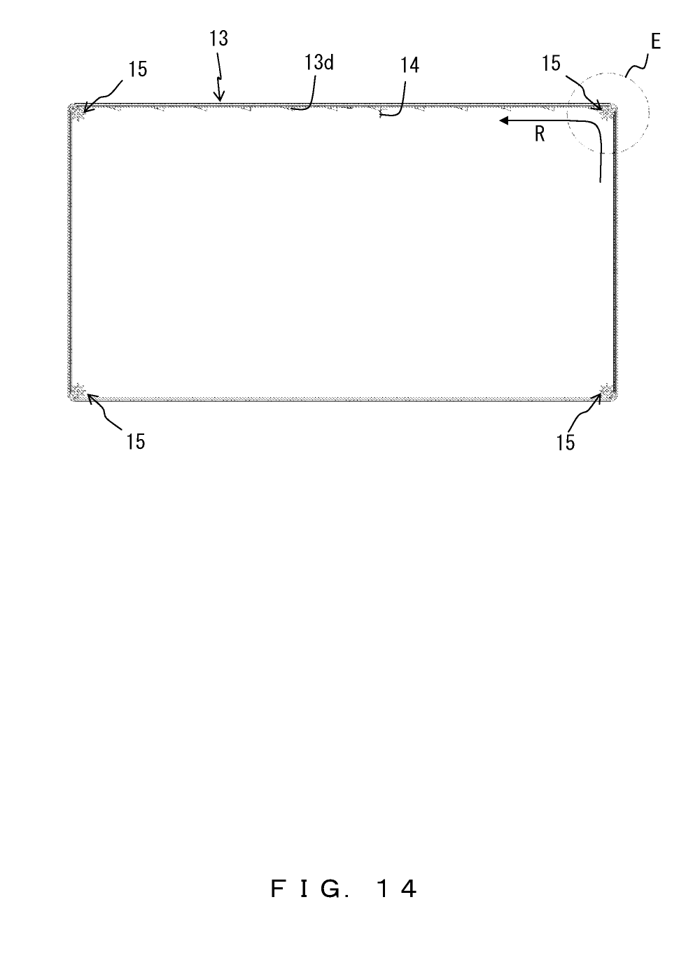

First, as illustrated in FIGS. 14, 15, and the like, the motor 15a of the filter driving part 15 drives the driving axis 15d in the counterclockwise direction in a planar view. Since the upper side gear 15b and the lower side gear 15c are fixed to the driving axis 15d, it turns in the counterclockwise direction with the driving axis 15d.

The movable filter structure 13 circles around in the circumferential direction that is in the counterclockwise direction (arrow R) as illustrated in FIG. 11, with the upper side meshing hole 13f of the upper side filter holding part 13b meshing with the upper side gear 15b, and the lower side meshing hole 13g of the lower side filter holding part 13c meshing with the lower side gear 15c, respectively.

The movable filter structure 13 is guided by the upper side guide holes 12g to 12j and the lower side guide holes 12k to 12n into which the convex part 13j for the upper side guide and the convex part 13k for the lower side guide are inserted, as illustrated in FIGS. 18 and 19. This makes the movable filter structure 13 circle around in the above mentioned circumferential direction along the frame structure 12.

In addition, as mentioned above, the upper side guide hole 12h and the lower side guide hole 121 of the right side part 12b of the frame structure 12 are inclined at the angle e respectively from the horizontal plane so that they are distanced from each other as they move from the front end side to the rear end side.

Regarding the intervals between the upper side guide hole 12h and the lower side guide hole 121, the length at the front end of the right side surface part 12b is the length H1, while the length at the rear end is H2. Since the length in the horizontal direction of the upper side guide hole 12h and the lower side guide hole 121 is the length L, the length H2 is represented by “H1+2×(Ltanθ)”.

Thus, in the filter 13a, the degree of pulling in the height direction is enhanced as the filter 13a moves from the front end side to the rear end side of the right side surface part 12b, and at the rear end, it is pulled in the height direction by the length “H2−H1” (=2×(Ltaneθ) . By this pulling, the filter 13a and eventually the movable filter structure 13 expand (the filter 13a′ in the sectional view taken along II-II in the left side of the page of FIG. 18).

As mentioned above, the movable filter structure 13 circles around maintaining the state where it is pulled in the height direction and expanded even between the upper side guide hole 12i and the lower side guide hole 12m, which are parallel with each other, the back surface part 12c. Then, the degree that the movable filter structure 13 is pulled from the rear end to the front end is weakened between the upper side guide hole 12j and the lower side guide hole 12n (the filter 13a″ illustrated in FIG. 19) and it restores its original height at the front end of the left side part 12d.

At the back surface part 12c in which the filter 13a is in an expanded state, the projection parts 13d and 13e of the upper side filter holding part 13b and the lower side filter holding part 13c press the upper side pressed part 14f and the lower side pressed part 14g of the dust removing structure 14 at the time of circling (see FIGS. 13A and 13B). In this way, the upper side projection part 13d and the lower side projection part 13e cause the duster part 14a to be distanced from the movable filter structure 13, and as a result of its reaction, as illustrated in FIG. 13C, cause the duster part 14a beat the expanded movable filter structure 13 (filter 13a).

In the present embodiment described so far, the filter device 10 includes an inclining panel 11 which separates the space to the side of the first electronic device housing device 2 and to the side of the second electronic device housing device 3, and a movable filter structure 13 circling around this inclining panel 11. Therefore, the movable filter structure 13 may absorb dust and the like included in the suction air to the first electronic device housing device 2 by the entire movable filter structure 13. Therefore, according to the present embodiment, the maintenance load of the filter may be reduced.

Further, since the movable filter structure 13 circles around the inclining panel 11, dust which are included in the suction air to the first electronic device housing device 2 may be absorbed as well as being capable of discharging dust by the discharging air from the second electronic device housing device 3.

In the present embodiment, the filter device 10 includes a dust removing structure 14 which removes dust adhering to the movable filter structure 13. Therefore, the maintenance load for filters may further be reduced.

In the present embodiment, the movable filter structure 13 circles around the circumference of the intake duct of the suction air to the first electronic device housing device 2 (the window part 12e of the front surface part 12a of the frame structure 12) and the discharge duct of the discharged air to the second electronic device housing device 3 (the window part 12c of the back surface part 12c). And the dust removing structure 14 removes dust in the above mentioned discharge duct (the window part 12f). Therefore, the removed dust may be prevented from adhering to the electronic device 20.

Also, in the present embodiment, the filter expansion structure (for example, the upper side guide holes 12g to 12j and the lower side guide holes 12k to 12n of the frame structure 12) expands the movable filter structure 13 (filter 13a) at the part where dust is removed by the dust removing structure 14 (for example, the back surface part 12c of the frame structure 12). Therefore, dust may be removed by the dust removing structure 14 more preferably.

Also, in the present embodiment, each interval of the upper side guide holes 12g to 12j and the lower side guide holes 12k to 12n of the frame structure 12 increases or decreases over the circumferential direction (arrow R). Therefore, the movable filter structure 13 (filter 13a) may be expanded via a simple constitution.

Also in the present embodiment, the upper side projection part 13d and the lower side projection part 13e of the movable filter structure 13 cause the duster part 14a to be distanced from the movable filter structure 13 at the time of circling, and cause the duster 14a to beat the movable filter structure 13 (filter 13a) as a result of its reaction. Therefore, dust may be removed via a simple constitution.

Also, in the present embodiment, the movable filter structure 13 includes a filter 13a, an upper side filter holding part 13b, and a lower side filter holding part 13c which hold this filter 13a. The upper side projection part 13d and the lower side projection part 13e are provided in the upper side filter holding part 13b and the lower side filter holding part 13c. Therefore, dust maybe removed via a simpler constitution.

Also, in the present embodiment, in the upper side projection part 13d and the lower side projection part 13e, concave parts (slits 13h and 13i) are formed which ease the bending stress applied when the movable filter structure 13 circles around. Therefore, this may prevent smooth circling of the movable filter structure 13 from being hindered by the upper side projection part 13d and the lower side projection part 13e.

All examples and conditional language recited herein are intended for pedagogical purposes to aid the reader in understanding the invention and the concepts contribute by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A filter device comprising:
an inclining panel which is arranged between a first electronic device housing device and a second electronic device housing device for housing electronic device, and which separates the space to the side of the first electronic device housing device and the space to the side of the second electronic device housing device; and
a movable filter structure which circles around to surround the circumference of the inclining panel.

2. The filter device according to claim 1, further comprising
a dust removing structure which removes dust adhering to the movable filter structure.

3. The filter device according to claim 2, wherein
the movable filter structure circles around to surround the circumference of the inclining panel over an intake duct of suction air to the first electronic device housing device and a discharge duct of discharged air from the second electronic device housing device, and
the dust removing structure removes the dust at the discharge duct.

4. The filter device according to claim 2, further comprising
a filter expansion structure which expands the movable filter structure at apart where the dust is removed by the dust removing structure.

5. The filter device according to claim 4, wherein the filter expansion structure includes two guide parts which guide the movable filter structure, and
the two guide parts increase or decrease intervals, respectively, over the circumferential direction of the movable filter structure.

6. The filter device according to claim 2, wherein
the dust removing structure includes a duster part which beats the movable filter structure, and
the movable filter structure includes a projection part which causes the duster part to be distanced from the movable filter structure at the time of circling, and due to the reaction, makes the duster part beat the movable filter structure.

7. The filter device according to claim 6, wherein
the movable filter structure further includes a filter and a filter holding part which holds the filter, and
the projection part is provided in the filter holding part.

8. The filter device according to claim 6, wherein
a concave part which eases bending stress applied at the time of circling of the movable filter structure is formed in the projection part.

9. A housing for electronic device, the housing comprising:
a first electronic device housing device which houses electronic device;
a second electronic device housing device which houses electronic device;
an inclining panel which is arranged between the first electronic device housing device and the second electronic device housing device, and which separates a space to the side of the first electronic device housing device and the space to the side of the second electronic device housing device; and
a movable filter structure circling around to surround the circumference of the inclining panel.

10. The housing for electronic device according to claim 9, the housing further comprising
a dust removing structure which removes dust adhering to the movable filter structure.

11. The housing for electronic device according to claim 10, wherein
the movable filter structure circles around to surround the circumference of the inclining panel over an intake duct of suction air to the first electronic device housing device and a discharge duct of discharged air from the second electronic device housing device, and
the dust removing structure removes the dust at the discharge duct.

12. The housing for electronic device according to claim 10, the hosing further comprising
a filter expansion structure which expands the movable filter structure at apart where the dust is removed by the duster removing part.

13. The housing for electronic device according to claim 12, wherein
the filter expansion structure includes two guide parts which guide the movable filter structure, and
the two guide parts increase or decrease intervals, respectively, over the circumferential direction of the movable filter structure.

14. The housing for electronic device according to claim 10, wherein
the dust removing structure includes a duster part which beats the movable filter structure, and
the movable filter structure includes a projection part which causes the duster part to be distanced from the movable filter structure at the time of circling, and due to the reaction, makes the duster part beat the movable filter structure.

15. The housing for electronic device according to claim 14, wherein
the movable filter structure further includes a filter and a filter holding part which holds the filter, and
the projection part is provided in the filter holding part.

16. The housing for electronic device according to claim 14, wherein
a concave part is formed which eases the bending stress applied at the time of circling of the movable filter structure is formed in the projection part.
